(19) United States
(12) Patent Application Publication
(10) Pub. No.: US 2005/0226003 A1
(43) Pub. Date: Oct. 13, 2005

(54) Backlight module and display device utilizing the same

(76) Inventors: Chi-Mao Hung, Chiayi City (TW); Che-Chih Chang, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/885,381

(22) Filed: Jul. 6, 2004

(30) Foreign Application Priority Data
Apr. 1, 2004 (TW) 93109038

(51) Int. Cl. F21V 7/00

(52) U.S. Cl. 362/613

(57) ABSTRACT

A backlight module. The backlight module for a display device has a first light-emitting device, a second light-emitting device, and a driving circuit. The first light-emitting device has a plurality of first light-emitting units arranged in series. The second light-emitting device has a plurality of second light-emitting units in series. The first light-emitting units and the second light-emitting are interlaced. The driving circuit drives the first light emitting device with a first voltage to emit light of a first brightness, and the second light emitting device with a second voltage to emit light of a second brightness.

### BACKGROUND OF THE INVENTION

1. Field of the Invention

The present invention relates to a backlight module, and in particular to a backlight module employed in a display device.

2. Description of the Related Art

FIG. 1 is a schematic diagram of a conventional liquid crystal display device comprising a panel P1 and backlight module B1. The backlight module B1 comprises a light guide G1 and two light-emitting devices 1T1 and 1T2. The light-emitting device 1T1 comprises light-emitting diodes 1A, 1B, and 1C coupled in series and emits light to the upper portion of the panel P1 through the light guide G1. The light-emitting device 1T2 comprises light-emitting diodes 1D, 1E, and 1F coupled in series and emits light to the lower portion of the panel P1 through the light guide G1. When any light-emitting diode of the light-emitting device 1T1 is damaged, the current path is interrupted, and none of the light-emitting diodes thereof can emit light. Thus, the upper portion of the panel P1 is dark.

Similarly, when any light-emitting diode of the light-emitting device 1T2 is damaged, the current path is similarly interrupted, and none of the light-emitting diodes thereof can emit light. Thus, the lower portion of the panel P1 is dark.

In a conventional liquid crystal display device, each light-emitting device provides light to one portion of the panel, with light-emitting diodes coupled in series. When any light-emitting diode of one light-emitting device is damaged, none of the light-emitting thereof can emit light, thus leaving one dark portion of the panel.

### SUMMARY OF THE INVENTION

Accordingly, the present invention provides a backlight module employed in a liquid crystal display device that ameliorates disadvantages of the related art.

According to the above described object, the present invention provides a backlight module having a first light-emitting device, a second light-emitting device, and a driving circuit. The first light-emitting device has a plurality of first light-emitting units arranged in series. The second light-emitting device has a plurality of second light-emitting units arranged in series. The first light-emitting units and the second light-emitting are interlaced. The driving circuit drives the first light emitting device with a first voltage to emit light of a first brightness, and the second light emitting device with a second voltage to emit light of a second brightness.

A detailed description is given in the following embodiments with reference to the accompanying drawings.

### BRIEF DESCRIPTION OF THE DRAWINGS

Various aspects of the present invention can be more fully understood by reading the subsequent detailed description and examples with references made to the accompanying drawings, wherein:

FIG. 1 is a schematic diagram of a conventional liquid crystal display device.

FIG. 2 is a schematic diagram of a display device utilizing the backlight module of the present invention.

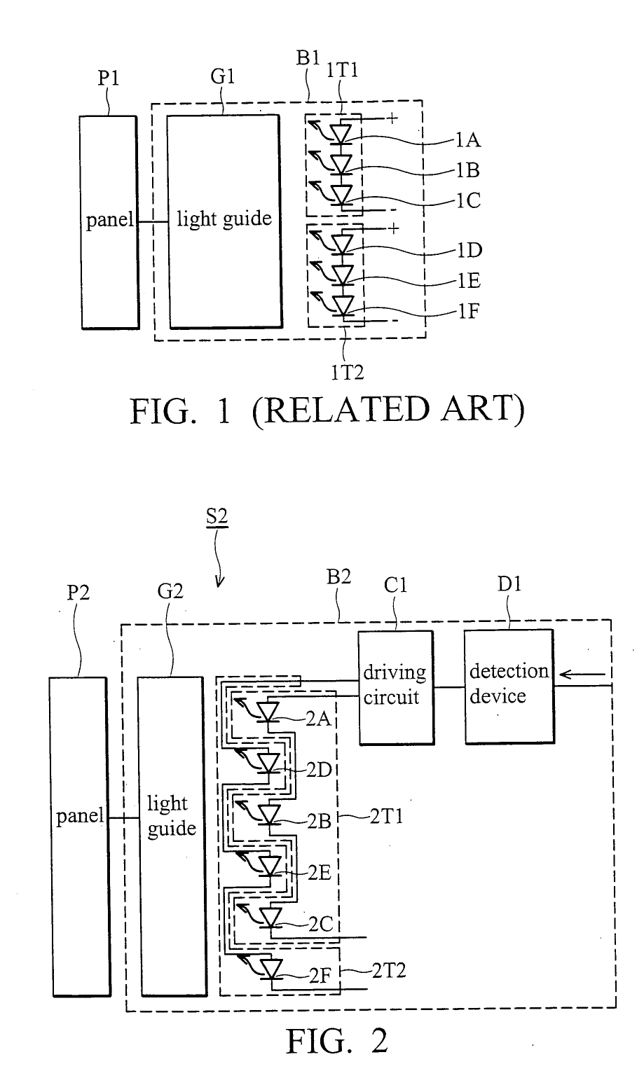

### DETAILED DESCRIPTION OF THE INVENTION

FIG. 2 is a schematic diagram of a display device utilizing a backlight module of the present invention. The display device S2 comprises a panel P2 and a backlight module B2. The backlight module B2 comprises a light guide G2, two light-emitting devices 2T1 and 2T2, a driving circuit C1, and a detection device D1. The light-emitting device 2T1 comprises light-emitting diodes 2A, 2B, and 2C connected in series, and the light-emitting device 2T2 comprises light-emitting diodes 2D, 2E, and 2F connected in series. The light-emitting diodes of the light-emitting device 2T1 and those of the light-emitting device 2T2 are interlaced on one side of the light guide G2. Referring to FIG. 2, the light-emitting diode 2D is disposed between the light-emitting diodes 2A and 2B, the light-emitting diode 2E between the light-emitting diodes 2B and 2C, and the light-emitting diode 2C between the light-emitting diodes 2E and 2F.

The driving circuit C1 provides a first voltage to drive the light-emitting device 2T1, such that the light-emitting diodes 2A, 2B, and 2C emit light of first brightness. Similarly, the driving circuit C1 provides a second voltage to drive the light-emitting device 2T2, such that the light-emitting diodes 2D, 2E, and 2F emit light of second brightness. The detection device D1 detects whether any light-emitting device has malfunctioned.

The light-emitting device 2T1 malfunctions when any light-emitting diode thereof is damaged. If the detection device D1 detects such malfunction, the driving circuit C1 provides a third voltage to the light-emitting device 2T2. The light-emitting diodes 2D, 2E, and 2F emit light of third brightness, equal to sum of the first and the second brightnesses.

Similarly, the light-emitting device 2T2 malfunctions when any light-emitting diode thereof is damaged. If the detection device D1 detects such malfunction, the driving circuit C1 provides the third voltage to the light-emitting device 2T1. The light-emitting diodes 2A, 2B, and 2C emit light of the third brightness.

In the present invention, light-emitting diodes of light-emitting devices are interlaced. When any light-emitting device malfunctions due to damage of any light-emitting diode thereof, the panel can still display images at only lower brightness, rather than becoming completely dark. When a detection device detects any light-emitting device malfunctions, a driving circuit provides a voltage to all other light-emitting devices to maintain emission at higher brightness. Thus, the backlight module of the present invention can provide sufficient brightness to the panel, and the display device can display images normally despite light-emitting device malfunction.

In the present invention, any number of light-emitting devices with any number of light-emitting diodes can be provided according to requirements, without limitation.

While several embodiments of the invention have been described by way of example, it is to be understood that the invention is not limited to the disclosed embodiments. To the contrary, it is intended that various modifications and similar arrangements (as would be apparent to those skilled in the art) be covered.

1. A backlight module comprising:
a first light-emitting device comprising a plurality of first light-emitting units connected in series;
a second light-emitting device comprising a plurality of second light-emitting units connected in series, wherein the first and the second light-emitting units are interlaced; and
a driving circuit driving the first light emitting device with a first voltage to emit light of a first brightness, and the second light emitting device with a second voltage to emit light of a second brightness.

2. The backlight module as claimed in claim 1, further comprising a detection device detecting whether any light-emitting device malfunctions, and if so, the driving circuit drives the other light-emitting device with a third voltage to emit light of a third brightness equal to sum of the first and the second brightnesses.

3. The backlight module as claimed in claim 1, further comprising a light guide, wherein the first and the second light-emitting units are disposed on one side of the panel.

4. The backlight module as claimed in claim 1, wherein the first and the second light-emitting units are light-emitting diodes.

5. The backlight module as claimed in claim 1, wherein the first voltage is equal to the second voltage.

6. A display device, comprising:
a panel displaying images; and
a backlight module comprising:
a plurality of light-emitting devices, each comprising a plurality of light-emitting units connected in series, wherein the light-emitting units of all light-emitting devices are interlaced; and
a driving circuit driving the light emitting devices with a first voltage to emit light of a full brightness.

7. The display device as claimed in claim 6, further comprising a detection device detecting whether any light-emitting device malfunctions, and if so, the driving circuit drives all other light-emitting devices with a second voltage to emit light of the full brightness.

8. The display device as claimed in claim 6, further comprising a light guide, wherein the light-emitting units are disposed on one side of the panel.

9. The display device as claimed in claim 6, wherein the light-emitting units are light-emitting diodes.
